(19) United States
(12) Patent Application Publication
(10) Pub. No.: US 2012/0188346 A1
(43) Pub. Date: Jul. 26, 2012

(54) MONITORING DEVICE AND METHOD FOR MONITORING AN ENTRY OR EXIT AREA OF AN ACCESS OPENING OF A VEHICLE TO A BUILDING COMPONENT

(75) Inventor: Andreas Schnabl, Biberbach (AT)

(73) Assignee: KNORR-BREMSE SYSTEME FÜR SCHIENENFAHRZEUGE GMBH, Munich (DE)

(21) Appl. No.: 13/391,763

(22) PCT Filed: Aug. 17, 2010
(86) PCT No.: PCT/EP2010/061984

§ 371 Date: Apr. 12, 2012

(30) Foreign Application Priority Data
Aug. 27, 2009 (DE) 10 2009 039 162.2

(51) Int. Cl. H04N 7/18; H04N 13/02; G06F 7/00

(52) U.S. Cl. 348/47; 701/49; 348/148; 348/E13.074; 348/E13.014; 348/E07.085

(57) ABSTRACT

A monitoring device for monitoring an entry or exit area of an access opening of a vehicle to a building component having an optical camera system including a first camera for providing a first image and a second camera for providing a second image, so that a stereo image can be generated from the first and the second image. The monitoring device also includes an analysis unit, such that at least one object in the entry or exit area can be detected from the stereo image and/or a position of the building component relative to at least one part of the vehicle can be determined from the stereo image for monitoring an entry or exit area.

### PRIORITY CLAIM

This patent application is a U.S. National Phase of International Patent Application No. PCT/EP2010/061984, filed 17 Aug. 2010, which claims priority to German Patent Application No. 10 2009 039 162.2, filed 27 Aug. 2009, the disclosures of which are incorporated herein by reference in their entirety.

### FIELD

Exemplary embodiments Disclosed embodiments relate to a monitoring device and a method.

### BACKGROUND

With regard to rail-bound vehicles, it is frequently necessary to monitor the door areas to implement either injury of passengers or its specific comfort function concerning the door control. Increasing use is being made of monitoring systems, and chiefly contactless systems, at interfaces where monitoring with the aid of contact-making means cause difficulties, for example owing to weather effects. The simplest design of such a monitoring unit is the light barrier, which is constructed from a transmission unit and a reception unit. If the light path is blocked by a person or an object, no light signal is recorded at the receiver, which corresponds to a blockage of the spatial area to be monitored. Light grid systems work on the principle of illuminating an object to be monitored with the aid of a light grid pattern to derive spatial coordinates for the object from reflections of the light grid pattern from the object. Ultrasonic sensors likewise work on a similar principle in the case of which 3D coordinates from acoustic reflections of an emitted sound signal may be received, evaluated and assigned to an object. The detection and evaluation of such acoustic signals is, however, very complicated. It has not so far been possible to implement the different monitoring functions, such as the detection of a person or object and the determination of the exact position in one unit or by means of a common physical measurement principle.

### SUMMARY

Disclosed embodiments provide an improved monitoring device and an improved method for monitoring an entry or exit area of an access opening of a vehicle to a building component. This is achieved by the disclosed monitoring device, and by the disclosed method for monitoring an entry or exit area of an access opening of a vehicle to a building component.

Disclosed embodiments provide a monitoring device for monitoring an entry or exit area of an access opening of a vehicle to a building component, the monitoring device having the following features:

an optical camera system with a first camera for providing a first image, and a second camera for providing a second image, the camera system being designed to generate a stereo image from the first and second images; and

an evaluation unit that, to monitor an entry or exit area, is designed to detect from the stereo image at least one object in the entry or exit area, and/or to determine from the stereo image a position of the building component relative to at least one part of the vehicle.

Disclosed embodiments provide a method for monitoring an entry or exit area of an access opening of a vehicle to a building component, the method having the following operations:

provision of an optical camera system with a first camera for providing a first image, and a second camera for providing a second image, and providing an evaluation unit, generating a stereo image from the first and second images;

monitoring the entry or exit area by using the stereo image, it being possible during the monitoring to detect at least one object in the entry or exit area, and/or to determine a position of the building component relative to at least one part of the vehicle.

Disclosed embodiments are based on the idea that an optical camera system for generating a stereo image can also be used to monitor a specific area (for example, in front of a door of a rail-bound vehicle). Such an optical camera system thus enables an integration of the functionality of different sensors. In the prior art, by contrast, it would be necessary to install a plurality of sensors for measuring different physical variables to be able to carry out an approximately equivalent monitoring of the entry and exit area. For example, the optical camera system can, on the one hand, be used to detect the presence of an object in the monitoring area, which could be implemented by a light barrier in the prior art. On the other hand, however, the identical camera system can also be used to determine spatial coordinates of this object in the monitoring area from the spatial information of the stereo image, which can be performed, by contrast, by an ultrasonic sensor in the prior art. Again, the camera system can further be used to determine a distance or a position of a part of a building (for example a platform edge) relative to the vehicle. All of said functionalities can be implemented simply on the basis of an evaluation of the acquired stereo image or of the two images acquired by the cameras of the optical camera system. Such an evaluation of the stereo image can be carried out in a technically simple fashion by the available evaluation routines and the powerful processors currently already available.

Disclosed embodiments offer utility in that there is now no longer any need to install many different sensors for the individual functionalities as a single unit supplies the desired information. A combination of various monitoring functions is thus implemented in one unit. This necessarily yields a cost reduction in the production of the above-named monitoring device.

In a disclosed embodiment, the optical camera system can be fastened on the vehicle. Such an embodiment offers utility in that the camera system is always positioned directly in the monitoring area in front of an access opening. Since it cannot be assumed that at a certain time the access opening of the vehicle is located at the same position in front of the building component, in the vicinity of which the camera system is positioned, it may be more advantageous to fasten the monitoring device completely on the vehicle. A unique determination of the position of persons or objects in the entry or exit area may thereby achieved.

In accordance with a particular embodiment, the optical camera system is fastened inside the vehicle in an area in the vicinity of the access opening, which also includes a deflecting unit for directing a field of view of the camera system into the entry and exit area. Such an embodiment has utility in that the monitoring device is protected against environmental effects and that damage from outside the vehicle is excluded. It is likewise possible to dispense with a watertight and dust-tight design.

In accordance with another embodiment, if the vehicle has a door closing the access opening, the evaluation unit can be designed to control the door in such a way that the door remains open when a person or an object is located in the entry or exit area of the vehicle. Such an embodiment offers utility in being able to provide a central control unit that also further controls the door in addition to evaluating the stereo image. This can lead to a reduction of the requisite electronic components, which provides a cost reduction.

In an additional embodiment, the vehicle can have an extendible step, it being possible to extend this into a step area between the access opening of the vehicle and the building component, and the evaluation unit being designed to detect an extended step. Such an embodiment has utility in that the detection of an extended step is a decision feature for clearing the departure of the vehicle so that an improvement of the operational safety by a central evaluation unit can be implemented very simply by the detection of persons or objects on the step. Furthermore, it can be established at which access opening of the vehicle a problem with a (for example, occupied) step is ongoing, and such a deficiency can therefore be more quickly remedied. An improperly retracted step can damage thereof and signify a risk of injury to persons in the area of the building component.

Furthermore, in accordance with a further embodiment, the device may comprise an evaluation unit that, upon extension of the step, is designed to detect a position of the step relative to the building component and to control the step in such a way as to observe a prescribed minimum spacing of the step from the building component. Such an embodiment offers utility in that an exact position of the building component relative to the vehicle can be determined to be able to determine exact position of the building component relative to the vehicle, thereby to protect the step against a collision with the building component.

It may also be useful if the device comprises an evaluation unit to deactivate an extension function of the step whenever a person or an object can be detected in an area between the vehicle and the building component. Such an embodiment may provide utility in that persons inadvertently trapped between building component and vehicle are not injured by an extended step. The step is likewise protected when objects are located in the interspace between building component and vehicle. The extension function is thereby blocked.

According to a further embodiment, the device may comprise an evaluation unit which may be designed to initiate a door movement when at least a person or an object can be detected in an area of the step. Such an embodiment has utility in that a warning may be output to the appropriate person in the area of the step before the door is closed, or to open the door when a person is climbing onto the step. Both monitoring functions may include a protective function for the relevant person.

It may also be useful, in another embodiment, for the device to have an evaluation unit which is designed to output a warning to a driver of the vehicle when at least a person or an object can be detected in a safety zone of the building component. Such an embodiment may have utility in that use of the stereo image enables the ability to automatically generate a detection message when persons or objects are located in a danger zone of the building component, and that it is possible to determine an exact position at which the detection of the appropriate persons or objects has taken place.

In an additional embodiment, the device can comprise an evaluation unit that enables a count of persons entering or exiting through the access opening of the vehicle. Such an embodiment has utility in that use of the stereo image enables the ability to count the number of the persons entering or exiting, as a result of which an entering or exiting persons can be counted so that a number of persons located in the vehicle at one time can be determined. This is very helpful in the event of danger to obtain knowledge of the number of persons still missing. Equally, the data relating to the number of persons being conveyed per day in the vehicle can be used to yield use statistics.

### BRIEF DESCRIPTION OF THE FIGURES

Exemplary embodiments are explained in more detail below with reference to the attached drawings, in which:

FIG. 1 shows an illustration in side view of an arrangement of components that can be used in an exemplary embodiment;

FIG. 2 shows an illustration in side view of different areas that can be monitored in accordance with an exemplary embodiment; and

FIG. 3 shows, as a method, a flowchart of an exemplary embodiment.

### DETAILED DESCRIPTION

In the following description of the exemplary embodiments, the same or similar reference numerals are used for the similarly acting elements in the various drawings, there consciously being no repeated description of these elements. The exemplary embodiments described below are selected only by way of example and can be combined with one another. If an exemplary embodiment comprises an “and/or” conjunction between a first feature and a second feature, this can be read to the effect that the exemplary embodiment in accordance with one embodiment has both the first feature and the second feature, and in accordance with a further embodiment has either only the first feature or only the second feature.

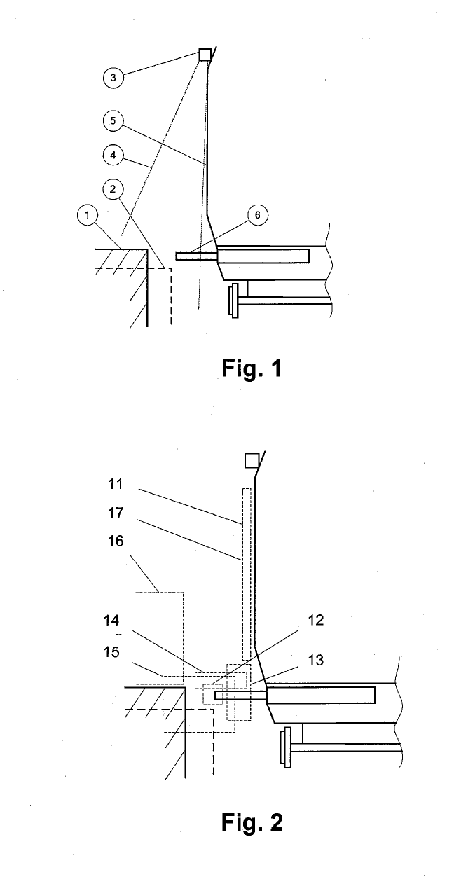

FIG. 1 is an illustration in side view of an arrangement of components that can be used in an exemplary embodiment. In this case, a platform edge 1 is illustrated as building component (at an alternative height 2, for example at another railroad station). Furthermore, a camera system 3 is fitted on a rail-bound vehicle, specifically above a door area of the rail-bound vehicle, to detect the entry and exit area in a prescribed solid angle of the scanning area 4. By way of example, the door area 5 forms the area in the vicinity of the access opening. Also illustrated is the step 6, which is extended on the vehicle approximately at the height of the platform edge.

One aspect of the disclosed embodiments refers to enabling an entry and exit area of the door 4, for example, of a rail-bound vehicle with automatic door systems. To simplify matters, reference is made in the further course of the description only to a vehicle, the vehicle being a rail-bound vehicle, a truck with a monitorable loading opening, or another vehicle. This monitoring system integrates the properties of different sensor systems in one unit, emphasis being placed on a contactless mode of operation and a determination of position information of the platform as particular features. In this case, the entire camera system 3 is advantageously mounted on the rail-bound vehicle in the door area. The sensor system 3 fitted in the door area is capable of executing a monitoring function by evaluating the stereo image or the two individual images of the first and second cameras. Monitoring is carried out in the area of the door space 4 with an opened and closing door, it thereby being possible, for example, to support anti-trapping protection of persons in this area. Monitoring of the extension and retraction functions of the step 6 leads to a redundant interrogation as to whether the step has been retracted or extended. In addition to said functions, it is also possible to use the optical camera system to monitor whether interfering elements are located in the clearance area profile 4 and whether, upon being detected they activate an algorithm that results in a delay to the departure of the train. Furthermore, the same camera system can be used to achieve monitoring of the presence of persons or objects on the step 6.

To attain a detection of the platform edge 1 by the optical camera system 3 and to enable the exact position coordinates to be returned, there is a need for an extended scanning area 4 that also enables persons or objects to be detected on a safety zone of the platform in front of a platform edge. To this end, it is possible, for example, to extend the monitoring area beyond an area of the platform edge (that is to say in a direction averted from the vehicle). This extended scanning area can be used to detect persons in the platform edge vicinity, these data, which may be obtained from the stereo image, being used in safety monitoring. A further property of the monitoring system with evaluation of the stereo image is the application as a counter system for persons entering and exiting, which system can also be denoted as a passenger counting system. It may be remarked in summary that the optical sensor system 3 can be used to monitor a scanning area 4, while different scanning areas, such as platform edges 1 or 2, or the door area 5 and/or the step area 6 can be monitored separately by various interrogations or evaluations of the stereo image of the camera system 3, and the data obtained from the corresponding monitoring can be evaluated. Subsequently, different areas of the entry and exit area, in which specific monitoring functions may be executed, can be presented in more detail.

FIG. 2 shows an illustration in side view of different areas that can be monitored in accordance with an exemplary embodiment. Here, the monitoring zone 11 is provided for monitoring the door area. Furthermore, the monitoring zone 12 serves to control the function for extending and retracting the step. Data that relate to the monitoring zone 13 may be evaluated to check whether interfering elements may be located in the area of the step. If persons or objects are located in the monitoring zone 14, this is recorded as an intrusion into the step area. In addition to the detection of the platform edge, at the same time the exact position of the platform edge is determined relative to the vehicle in the monitoring zone 15. Evaluating the data from the monitoring zone 16 enables persons or objects in the danger zone of the platform to be detected. A count of persons entering and/or exiting is possible by the joint evaluation of data from the monitoring zones 11 and 17.

In accordance with an exemplary embodiment, the monitoring device comprises a sensor system 3 that can be mounted fixedly on the vehicle in the vicinity of the door area (above or to the side). The sensor system 3 substantially comprises two optical cameras, each individual camera being able to take an image. These two images may then be combined to form a stereo image, or the information from the two images is jointly evaluated to obtain distance information of objects in the monitored area, and to calculate therefrom an item of distance information per pixel, for example. By the use of smart software that is integrated in the evaluation unit, it is then possible to filter out various scanning areas within the field of view of the sensor system 4, and said scanning areas can be evaluated for the presence of objects. The sensor system 3 itself can be evaluated in the presence of objects. The sensor system 3 itself can be fitted in a special housing directly on the outside of the vehicle, or inside the vehicle, if appropriate with use of a deflection unit for deflecting the field of view into the entry and exit area. The camera system 3 can be activated starting from a certain (rest) speed when the vehicle is being halted, or not until the vehicle is stopped, depending on the function to be executed. Starting from the activation, at regular intervals (for example at a frequency of up to 20 images/second), images of the surroundings and/or of the area to be monitored may be recorded and appropriately evaluated. The functions described below can be implemented thereby.

If a monitoring zone 11 of the sensor system 3 is defined such that this is situated close to the outside of a door leaf, or can even project into the door area, the evaluation unit is capable of detecting persons and/or objects. This type of monitoring can be used to support or achieve anti-trapping protection of persons, given a door that is open and thereafter closing, when a door leaf is prevented from being able to close while a person is still located in this area. To be able to keep this monitoring active even as the door is closing, the monitoring zone can, for example, also be reduced dynamically in a fashion corresponding to the position of the door leaf in the closing area.

The evaluation of the monitoring zone 12 can be used to detect the presence or absence of the step. This monitoring can be necessary to establish the status of the step. Such a detection of the status of the step can, for example, be used to clear the vehicle for departure given that the step is retracted.

The monitoring zone 13 is defined to detect objects that may be trapped and project into the clearance area profile 4 and therefore exceed maximum permitted external measurement of the vehicle. It is likewise possible for persons or objects that are located in this area to be detected in order, thereby, not to endanger persons because of a step that has been extended.

Furthermore, an evaluation of data from the monitoring zone 14 enables persons and objects that are located on the step board to be detected. A corresponding door function can be initiated as a function of the result of the step monitoring. For example, the door can be caused to open if a passenger would like to enter the rail-bound vehicle or, given a door that is already closed, it is possible to warn the relevant person when the door is in the process of being closed.

The exact coordinates of the platform edge can be determined by monitoring a monitoring zone 15, and evaluating the data obtained from said monitoring zone 15. This information can be used by the evaluation unit to control the step board that is to be extended in such a way that it is positioned as near as possible to the platform with a slight residual gap. A very small residual gap size can avoid danger to persons from stepping off into the residual gap.

By monitoring objects in a monitoring zone 16, it is possible to detect persons in the danger zone of the platform, and to generate appropriate warnings to the driver, or to prevent the train from departing when persons or other objects are located in said monitoring area 16. Automated safety monitoring is thereby achieved, and so measures for avoiding injuries to persons can be instituted in an appropriately rapid and reliable fashion.

A counting system for persons entering and exiting can be implemented by the possible detection of the movement direction of objects or persons that may be implemented by evaluating data from two different defined monitoring areas or monitoring zones 11 and 17. In addition to the different sensor systems, it is thereby possible to implement a passenger counting system very easily by evaluating the stereo image of the camera system.

Furthermore, it is not necessary for the above defined functions to be used simultaneously in all exemplary embodiments. Even only individual monitoring functions can be implemented by means of the pixel evaluation on the basis of the universality of the sensor system. It is possible to implement yet further monitoring options that have not been set forth separately. Depending on the application, the sensor system can be connected to the door control via permanently laid lines or via any desired bus systems (such as, for example: CAN-Bus, Ethernet, etc.). Depending on the selected monitoring function, the corresponding information is transmitted to the door control, where it is appropriately evaluated or the appropriate function is initiated, for example the positioning of the step board 6 from a definition of the distance of extension or reserving the door 5 when there are persons in the door area.

By way of example, it would also be conceivable to use the approach proposed here for the purpose of monitoring the approach or the loading of a truck at a loading ramp (that is to say, the building component). The door opening would then, for example, be the rear opening of the truck via which the truck is loaded or unloaded by a store worker or the truck driver. Said functionalities can, however, likewise be advantageously used in this case.

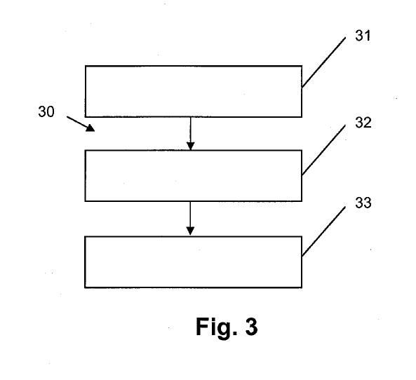

FIG. 3 shows a flowchart of a method 30 for monitoring an entry or exit area of an access opening of a vehicle to a building component. The method in this case comprises a step of providing 31 an optical camera system with a first camera for providing a first image, and a second camera for providing a second image, and of providing an evaluation unit. The method further has a step of generating 32 a stereo image from the first and second images. In a further step of the monitoring 33, an entry or exit area is monitored by using the stereo image, it being possible during the monitoring to detect at least one object in the entry or exit area, and/or to determine a position of the building component relative to at least one part of the vehicle.

### LIST OF REFERENCE NUMERALS

### 1 Platform

2 Platform (alternative height)
3 Camera system
4 Solid angle, scanning area
5 Door area

### 6 Step

11 Monitoring zone of the door space
12 Monitoring zone of the step function
13 Monitoring zone for interfering elements in the clearance area profile
14 Monitoring zone of the step area
15 Monitoring zone of the platform edge
16 Monitoring zone for persons in the platform edge vicinity
17 Counting system (together with 11)
30 Method for monitoring
31 Step of providing
32 Step of generating a stereo image
33 Step of monitoring an entry or exit area

1. A monitoring device for monitoring an entry or exit area of an access opening of a vehicle to a building component, the monitoring device comprising:
an optical camera system with a first camera for providing a first image, and a second camera for providing a second image, the camera system generating a stereo image from the first and second images; and
an evaluation unit that monitors an entry or exit area and detects, from the stereo image, at least one object in the entry or exit area, and/or determines, from the stereo image, a position of the building component relative to at least one part of the vehicle.

2. The device of claim 1, wherein the optical camera system is fastened on the vehicle.

3. The device of claim 1, wherein the optical camera system is fastened inside the vehicle in an area in the vicinity of the access opening.

4. The device of claim 1 wherein the vehicle has a door closing the access opening, and wherein the evaluation unit controls the door in such a way that the door remains open when a person or an object is located in the entry or exit area of the vehicle.

5. The device of claim 1, wherein the vehicle has an extendible step that can be extended in a step area between the access opening of the vehicle and the building component, and wherein the evaluation unit is designed to detect an extended step.

6. The device of claim 5, wherein the evaluation unit is designed to detect a position of the step relative to the building component and to control the step in such a way as to observe a prescribed minimum spacing of the step from the building component.

7. The device of claim 5, wherein the evaluation unit is designed so as to deactivate an extension function of the step whenever a person or an object can be detected in an area between the vehicle and the building component.

8. The device of claim 5, wherein the evaluation unit is designed to initiate a door movement when at least a person or an object is detected in an area of the step.

9. The device of claim 1, wherein the evaluation unit outputs a warning to a driver of the vehicle when at least a person or an object is detected in a safety zone of the building component.

10. The device of claim 1, wherein the evaluation unit carries out a count of persons entering or exiting through the access opening of the vehicle.

11. A method for monitoring an entry or exit area of an access opening of a vehicle to a building component, the method comprising:
providing an optical camera system with a first camera for providing a first image, and a second camera for providing a second image, and providing an evaluation unit,
generating a stereo image from the first and second images;
monitoring the entry or exit area using the stereo image to detect at least one object in the entry or exit area, and/or to determine a position of the building component relative to at least one part of the vehicle.
